(19) United States
(12) Patent Application Publication
(10) Pub. No.: US 2010/0276293 A1
(43) Pub. Date: Nov. 4, 2010

(54) ANTI-CORROSION SYSTEM FOR METALS AND PIGMENT THEREFOR

(75) Inventors: Franz Priewasser, St. Georgen (AT); Karl-Heinz Stellnberger, Niederneukirchen (AT); Siegfried Wiesinger, Wartberg (AT); Josef Hagler, Leonding (AT); Gerald Luckeneder, Pinsdorf (AT)

Correspondence Address: Setter Roche LLP, P.O. Box 780, Erie, CO, 80516, US

(73) Assignee: VOESTALPINE STAHL GMBH, Linz (AT)

(21) Appl. No.: 12/599,025

(22) PCT Filed: May 5, 2008
(86) PCT No.: PCT/EP2008/003718

§ 371 Date: Jun. 17, 2010

(30) Foreign Application Priority Data
May 8, 2007 (DE) 10 2007 021 602.7

(51) Int. Cl. C25D 3/00; C08K 3/08; C09C 1/62; C08L 63/00; C09C 1/64

(52) U.S. Cl. 205/317; 524/440; 106/403; 523/458; 106/404

(57) ABSTRACT

The invention relates to an anti-corrosion system for metals consisting of at least one finish or coating that can be applied to a metal, said finish or coating comprising an organic matrix. The organic matrix also contains anti-corrosion pigments, which are finely distributed throughout the organic matrix. The anti-corrosion pigments are formed from a metal alloy of at least two metals and optionally from inevitable impurities. The invention also relates to a corresponding anti-corrosion pigment.

### FIELD OF THE INVENTION

The invention relates to an anticorrosion system and in particular, a coating system for metals and a pigment therefor.

### BACKGROUND OF THE INVENTION

In metallic components and in particular the bodies of motor vehicles, various corrosion problems occur, the first being a corrosion from the outside in, where the corrosion causes subcoating rust to develop. This corrosion is more cosmetic in nature.

There is also a corrosion from inside out, which occurs in crimped and flanged regions and frequently leads to occurrences of rust breakthrough.

According to the prior art, metallic components are temporarily protected from corrosion by means of an undercoating, a so-called anticorrosion primer. Currently, organic, metallic, and inorganic anticorrosion pigments are built into these organic paint systems, e.g. zinc, silicates, phosphates, chromates, etc., which are intended to protect the substrate surface by means of various mechanisms (e.g. ion exchange).

But in continuously moist areas, these paint systems break down and bubbles form due to corrosion of the substrate, which causes a peeling of the paint that further accelerates the corrosive action. The conventional anticorrosion systems on metals appear as follows in the example of steel: a metallic coating is provided, which is applied electrolytically or by means of a hot-dip coating process. The most frequently used coating metal is zinc, followed by zinc-aluminum coatings and aluminum coatings. Sheet metals of this kind are pretreated by means of chromating, pretreated in a chromate-free fashion, or pretreated by means of phosphating, then the known anticorrosion primer is applied, to which a single-layer or multilayer topcoat is applied.

An extremely wide variety of systems and in particular, an extremely wide variety of primers, are known from the prior art.

DE 103 007 51 A1 has disclosed a method for coating metallic surfaces, coating compounds, and coverings manufactured in this way. The essentially organic compounds described therein also contain organic and/or inorganic corrosion inhibitors and optionally, other additives such as pigments. The corrosion inhibitors should be anticorrosion pigments and compounds based on titanium, hafnium, zirconium, carbonate, and/or ammonium carbonate; preferably, the anticorrosion pigments should be based on silicic acids, oxides, and/or silicates, e.g. earth alkali-containing anticorrosion pigments. Examples of these include in particular calcium-modified silicic acid and silicate pigments. Furthermore, anticorrosion pigments, each based on at least one respective oxide, phosphate, and/or silicate, can be used as the anticorrosion pigments.

EP 1 030 894 B1 has disclosed a conductive, organic coating used as a so-called anticorrosion primer, which should have a favorable degree of weldability.

For this purpose, it contains fine-grained conductive fillers such as powdered zinc, powdered aluminum, graphite and/or molybdenum sulfite, carbon black, iron phosphite, or barium sulfate doped with tin or antimony. In addition, it can contain anticorrosion pigments such as zinc-calcium-aluminum-strontium-polyphosphate-silicate hydrate, zinc-boron-tungsten-silicate, or doped CO₂.

DE 25 60 072 has disclosed the manufacture of pigment based on iron oxide and its use for corrosion protection; in addition to iron, this pigment can also contain magnesium and/or calcium oxides, which in addition to calcium and/or magnesium, can also contain zinc through substitution of the corresponding molar quantities.

DE 102 47 691 A1 has disclosed a mixture for applying a polymeric, corrosion-resistant, wear-resistant, formable coating and a method for manufacturing this coating. For example, it should be possible to apply the mixture to a galvanized steel sheet; the mixture contains electrically conductive and/or semiconducting elements selected from the group of electrically conductive and/or semiconducting particles, but also contains iron phosphite or metallic zinc as well as optionally, up to 5 wt. % graphite and/or molybdenum sulfite. These should have a certain grain size distribution. These electrically conductive and/or semiconducting particles should be selected from among those based on boride, carbide, oxide, phosphide, phosphate, silicate, and/or silicide, for example based on aluminum, chromium, iron, calcium, calcium-magnesium, manganese, nickel, cobalt, copper, lanthanum, lanthanide, molybdenum, titanium, vanadium, tungsten, yttrium, zinc, tin, and/or zirconium.

DE 102 17 624 A1 has disclosed a mixture for applying a polymeric, corrosion-resistant, wear-resistant, formable coating and a method for manufacturing this coating, which essentially corresponds to those in the already-cited DE 102 47 691 A1.

EP 1 050 603 B1 has disclosed a surface-treated sheet steel with excellent corrosion resistance. This coated sheet steel includes a sheet steel that is coated with zinc or a zinc alloy or a sheet steel that is coated with aluminum or an aluminum alloy and a composite-oxide coating that is formed on the surface of the coated sheet steel, as well as an organic coating that should be situated on the composite-oxide coating. In addition to fine oxide particles, the composite-oxide coating contains at least one metal, selected from the group comprising magnesium, calcium, strontium, and barium, including possible combinations or alloys, and phosphoric acid or a phosphoric acid compound; the organic coating includes a product of a reaction between a film-forming organic resin and a compound laden with active water; part or all of the compound is a hydrazine derivative. It is assumed that even if defects occur in the coating, a cathodic reaction of OH⁻ ions is released, which shifts the surface into the alkaline range and magnesium ions and calcium ions are released in the form of magnesium hydroxide and calcium hydroxide, which, as airtight, only slightly soluble reaction products, produce a seal around the defects. The hydrazine derivative in this case should be able to form a stable passive layer by means of a powerful bond with the surface of the first layer and rearranges the zinc ions, which are released in a corrosion reaction, thus forming an insoluble, gelled layer.

GB 846904 has disclosed a pigment composed of a binary zinc-magnesium alloy that can be used in paints. This pigment should be particularly stable in relation to corrosion so that with this pigment in the paint, it should be possible to achieve a certain barrier against corrosion. In order to protect the pigments in the paint from corrosion, it should be advantageous to protect the paint with an additional coating.

The object of the invention is to create an anticorrosion system that reliably prevents corrosion and when corrosive action occurs, develops an additional protective mechanism.

Another object of the invention is to create a pigment for the anticorrosion system.

### SUMMARY OF THE INVENTION

According to the invention, an organic matrix, e.g. a paint, a glue, or a so-called anticorrosion primer contains alloyed metallic pigments, e.g. zinc-magnesium alloyed pigments or alloyed zinc-aluminum-magnesium pigments, optionally with zinc pigments mixed into them. An organic matrix of this kind is used, for example, as an anticorrosion primer on autobody sheets, as an adhesive for autobody sheets or also for applications other than in motor vehicles, or in paints such as paints used in the household appliance industry, the automotive industry, or the like. According to the invention, these pigments in an organic matrix can also be used in heavy-duty anticorrosion applications such as shipbuilding.

Surprisingly and without a clear explanation of the effects, it has turned out that with the use of alloyed metallic pigments, i.e. pigments not in an inorganic, mineral, or ionic form, e.g. zinc-magnesium alloyed pigment particles or zinc-aluminum-magnesium alloyed pigment particles, an entirely unexpected reaction takes place with the occurrence of corrosive action.

It has been possible to determine that with occurrences of corrosive action, the particles in the organic matrix are released, the released metal migrates to the surface of the metal substrate or to a surface of the steel substrate coating composed metal and precipitates a passive layer there. What takes place, therefore, is a corrosion-induced rearranging of the pigment metals and formation of the passive layer. The mechanism is so effective that the zinc coating on sheet steel and the paint coating thickness can be reduced, so that the cosmetic corrosion, the corrosion in continuously moist areas, and flange corrosion occur to a considerably lesser degree than in all of the known anticorrosion systems in the prior art.

The invention permits a secondary anticorrosion measure, e.g. for eliminating or significantly reducing the need for flooding with wax preservatives or cavity preservatives.

In addition, it is possible to use new designs that are more advantageous in manufacture (without hidden edges) and are subject to fewer limitations in the manufacture of components.

In comparison to the conventional ratio of 1:4 to 1:6, the bonding agent-to-pigment ratio in the system according to the invention can even be set to 1:1 to 1:4, in particular 1:1 to 1:2, particularly preferably 1:1.6.

Furthermore, hydrophobizing agents and waxes can be used as forming additives; for example silanes can be used as hydrophobizing agents and for example carnauba can be used as a forming additive.

The achievable paint layer thickness can be reduced to 1 to 4 μm, in particular to 1.5 to 3.5 μm, in lieu of the conventional 3 to 5 μm. Furthermore, a reduced non-volatile matter density of <2.0 (conventionally approx. 3.5) yields an increase in the paint coverage rate (up to 30% less paint consumption).

In addition, the paint system according to the invention can be formable and therefore have a significantly lower tool wear.

The invention succeeds surprisingly well in combining the intrinsically contradictory goals of weldability on the one hand and corrosion protection on the other.

In particular, the invention relates to an anticorrosion system for metals, which is composed of at least one covering or coating to be applied to a metal; the covering or coating contains an organic matrix; the organic matrix also contains anticorrosion pigments; the anticorrosion pigments are finely distributed in the organic matrix, and the anticorrosion pigments are made of a metal alloy composed of at least two metals and possibly unavoidable impurities.

Also in the invention, the anticorrosion pigments are made of a metal alloy composed of at least three metals and possibly unavoidable impurities.

The invention also relates to the organic matrix, which is an undercoating for a paint structure and/or an anticorrosion primer for a paint structure and/or a chromophoric paint of a paint structure and/or a topcoat of a paint structure and/or a paint for coating a metal and/or an adhesive for joining metal sheets and/or an oil and/or a wax and/or an oil/wax emulsion.

The invention also relates to an anticorrosion system, which includes a metallic covering for the metal substrate; the metallic covering, functioning as a protective layer, provides a cathodic corrosion protection or a barrier corrosion protection.

The invention also relates to a cathodic protective layer, which is a zinc layer and/or a zinc-aluminum layer and/or a zinc-chromium layer and/or a zinc-magnesium layer and/or a galvannealed layer (zinc-iron layer) or another cathodically acting protective layer.

The invention also relates to a barrier protective layer, which is composed of aluminum and/or aluminum alloys and/or tin and/or copper and/or other metals that are electrochemically more inert than the covered metal substrate.

According to the invention, the protective layer can be a protective layer that is deposited onto the substrate by means of electrolysis and/or the hot-dip method and/or the PVD method and/or the CVD method.

Also according to the invention, at least one of the alloy metals of the anticorrosion pigment corresponds to a metal or the metal of the metallic anticorrosion layer.

The invention also relates to at least two of the metals composing the alloy of the anticorrosion pigment, which can be alloyed with each other.

The invention also relates to the elements composing the anticorrosion pigment; the elements are from different main groups of the chemical periodic system.

According to the invention, as alloy components, the anticorrosion pigments contain elements of the third, fourth, and fifth periods of the second, third, and fourth main groups and subgroups.

In one embodiment, the anticorrosion pigments are an alloy of metals of the second main group and the second subgroup.

The invention also relates to the alloy for the anticorrosion pigments; the alloy contains metals of the fourth period of the eighth subgroup.

According to the invention, this alloy can contain zinc, iron, aluminum, magnesium, cerium, lanthanum, and/or chromium.

The invention also relates to other metallic pigments; for example, the pigments contain copper, tin bronze, zinc pigment mixtures, or graphite.

The invention also relates to other pigments that contain copper, tin bronze, zinc pigment mixtures, or graphite.

The invention also relates to a substrate; the substrate onto which the anticorrosion system is applied is a sheet steel.

The invention also relates to an intermediate or pretreatment layer, which is situated between the metallic protective layer and the protective layer containing the anticorrosion pigments and is composed of a chromating or phosphating, in particular with magnesium, aluminum, or silicon phosphates.

The invention also relates to metals in the pigment; these metals are electrochemically more inert metals such as copper, silver, platinum, or gold.

The invention also relates to an organic matrix; the organic matrix is essentially a polyester paint.

The invention also relates to the organic matrix; in order to improve paint adhesion, the matrix contains 1 to 5% melamine resins and/or epoxy resins and/or blocked isocyanate resins.

The invention also relates to the use of the anticorrosion system as an anticorrosion primer and/or paint; the anticorrosion system is applied to the substrate in paint layer thicknesses of 1 to 4 μm.

The bonding agent-to-pigment ratio can be from 1:1 to 1:4.

Preferably, the bonding agent-to-pigment ratio is from 1:1 to 1:2.

Even more preferably, the bonding agent-to-pigment ratio is from 1:1.4 to 1:1.6.

The invention also relates to the organic matrix; in addition to a paint component and/or resin component, the matrix contains waxes as forming additives.

Also according to the invention, hydrophobizing agents can be included; the hydrophobizing agents are contained in the matrix.

Also according to the invention, silanes can be included as hydrophobizing agents.

The invention also relates to an anticorrosion pigment for use in an anticorrosion system, particularly for use in an organic matrix for protecting a coated or uncoated metal substrate; the pigment is made of a metal alloy composed of at least two metals and possibly unavoidable impurities.

The invention also relates to the anticorrosion pigment; the anticorrosion pigment is made of a metal alloy composed of at least three metals and possibly unavoidable impurities.

The invention also relates to at least one of the alloy metals of the anticorrosion pigment; the alloy metal corresponds to a metal or the metal of the metallic anticorrosion layer.

According to the invention, at least two of the metals composing the alloy of the anticorrosion pigment can be alloyed with each other.

The invention also relates to the elements composing the anticorrosion pigment; the elements are from different main groups of the chemical periodic system.

Also according to the invention, alloy components of the pigment can include elements of the third, fourth, and fifth periods of the second, third, and fourth main groups and subgroups.

The invention also relates to the anticorrosion pigment; the anticorrosion pigment is an alloy of metals of the second main group and the second subgroup.

In one embodiment of the invention, the alloy contains metals of the fourth period of the eighth subgroup.

According to the invention, zinc, iron, aluminum, magnesium, cerium, lanthanum, and/or chromium can be used as the metals composing the alloy.

The invention also relates to a pigment; the pigment is essentially a zinc-aluminum-magnesium alloy.

The invention also relates to the alloy of the anticorrosion pigment(s); the anticorrosion pigment also contains metals that are electrochemically more inert than the essential alloy components in order to stimulate the breakdown of the alloy components that form the passive layer.

According to the invention, copper, silver, platinum, or gold are contained as metals that are electrochemically more inert than the essential alloy components.

The invention relates to the use of anticorrosion pigments in an anticorrosion system for coating metals as an anticorrosion layer.

The invention will be described by way of example in conjunction with the drawings.

### BRIEF DESCRIPTION OF THE DRAWINGS

FIG. 1 shows a first layer construction for use as a paint system in the automotive field.

FIG. 2 is a comparison of the corrosion mechanisms in the prior art and in the invention.

FIG. 3 shows cross-sectional electron microscope images after the occurrence of a corrosive action according to DIN EN ISO 9227 (500 hours) in the prior art and in the invention.

FIG. 4 shows an electron microscope image of an anticorrosion pigment according to the invention.

FIG. 5 shows a cross-sectional electron microscope image of a layer structure according to the invention before an occurrence of corrosive action and the cross section of the layer structure according to the invention after an occurrence of corrosive action.

### DETAILED DESCRIPTION OF THE PREFERRED EMBODIMENTS

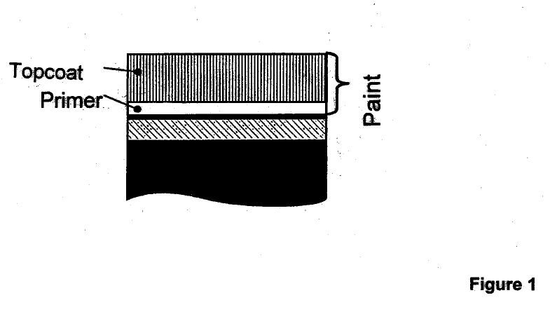

The layer structure according to the invention (FIG. 1) includes a metal substrate 1, for example a sheet metal such as sheet steel, which is to be protected from corrosion.

A metallic protective layer 2 can be applied to the substrate 1. The metallic protective layer 2 is for example a protective layer 2 that functions as a cathodic protection or a barrier protection.

For the case in which it is a cathodic protective layer 2, the protective layer 2 is for example a zinc layer, a zinc-aluminum layer, a zinc-chromium layer, a zinc-magnesium layer, or another cathodically acting protective layer such as a galvannealed layer.

The cathodic protective layer 2 can be deposited onto the substrate 1 by means of the hot-dip method, electrolysis, or other known methods such as the PVD method or the CVD method.

For the case in which the protective layer 2 is a barrier protective layer, this barrier protective layer 2 is composed, for example, of aluminum, aluminum alloys, tin, or similar metals.

A barrier protective layer 2 can also be deposited by means of the hot-dip method, electrolytically, or by means of the CVD or PVD method.

The layer 2 can also be embodied as multilayered and metallic.

Optionally, but not necessarily, a pretreatment layer 3 can be provided in order to improve paint adhesion. The pretreatment layer 3 can be a chromating or phosphating and is preferably a chromate-free pretreatment using magnesium phosphates.

A so-called primer 4 is applied to the pretreatment layer 3; the primer 4 contains the anticorrosion pigments according to the invention. The primer 4 contains an organic component and the anticorrosion pigments according to the invention as well as optional fillers and additives.

The organic components are for example monomers, oligomers, and polymers that can preferably be at least partially hardened anionically, cationically, and/or radically. Additional optional ingredients include organic solvents or water or alcohols. The organic component is in particular composed of organic components that comprise typical paints or anticorrosion primers of the type known from the prior art, in particular single-component or multi-component synthetic resins.

Preferably, a polyester paint is used as an organic component or as an organic bonding agent. Up to now, polyester paints of this kind have not been used in mass-produced anticorrosion paint systems. In addition, this paint can contain 1 to 5% melamine resins, epoxy resins, or blocked isocyanate, which significantly improves paint adhesion.

The selection according to the invention achieves a significantly improved paint flow and therefore a significantly improved surface. This also makes it possible to reduce the paint layer thickness so that when the system according to the invention is used, this also improves the weldability.

Additives can include, for example, thixotropy-influencing substances, adhesion agents, paint pigments, other metallic pigments functioning as welding additives, and other substances usually contained in anticorrosion primers.

In a particularly preferred embodiment according to the invention, forming additives such as waxes or hydrophobizing agents can be used. The waxes used here can be the waxes usually used as forming additives such as carnauba wax; preferably, silanes are used as the hydrophobizing agents.

Other metallic pigments such as copper, tin bronze, graphite, and in a particularly preferable embodiment, zinc pigment mixtures can also be present.

The anticorrosion pigments according to the invention are finely distributed in the organic matrix, both in the fluid form and in the hardened form, and are composed of an alloy of at least two metals.

If a protective layer 2 is provided, preferably at least one of the metals corresponds to the metal used as a protective coating 2 that covers the steel substrate 1. Depending on the protective layer 2, the anticorrosion pigments are thus composed of zinc-magnesium and/or zinc-aluminum and/or aluminum-magnesium and/or zinc-chromium alloys; alloys composed of three of the above-mentioned metals are also possible. In lieu of the metals mentioned above, it is also possible to use metals that are situated close to or are related to these metals in the electrochemical series and/or in the periodic system of elements, e.g. metals of the same main group.

In a purely general way, it can be said that the elements composing the anticorrosion pigment can come from different main groups or subgroups of the chemical periodic system; for example, the anticorrosion pigments are an alloy composed of metals of the second main group and the second subgroup. In particular, the alloy can contain or be composed of metals of the fourth period of the eighth subgroup and also, as an alloy component, elements of the third, fourth, and fifth periods of the second, third, and fourth main groups and subgroups.

With the use of zinc-containing anticorrosion pigments, it has surprisingly turned out that a reduction of the pigment content in the paint in favor of the proportion of bonding agent does not in fact change the anticorrosion properties for the worse but instead, significantly improves the weldability in a surprising way. The basis for this mechanism is unknown at this time. It is assumed that this effect is based on the low number of contact points that is conversely accompanied by an increased current passage per contact point.

The pigments can be surface treated or surface coated. For example, the pigments can be hydrophobized, in particular by means of silanization, which facilitates the intermingling into the organic matrix.

In another advantageous embodiment, in addition to the claimed metals, the layer 4 contains a certain proportion of metals that are electrochemically more inert or much more inert, e.g. Sn-bronze, copper, silver, gold, or platinum. It has been possible to determine that the presence of more inert metals stimulates or more precisely stated, accelerates, the breakdown of the pigments.

The layer 4 according to the invention can also be composed of a plurality of sublayers; for example, the sublayers contain anticorrosion pigments composed of different metals so that for example a first sublayer contains anticorrosion pigments according to the invention, e.g. composed of a zinc-magnesium alloy, and a second sublayer applied thereon contains anticorrosion pigments according to the invention, e.g. composed of aluminum-magnesium or zinc-chromium. Naturally, it is also possible for there to be a plurality of layers; the plurality of layers naturally increases the corrosion resistance, but also increases the corresponding costs.

A single-layer or multilayer topcoat, in particular a chromophoric topcoat, is applied to a layer 4 according to the invention that is embodied in this way; according to the invention, topcoats of this kind can optionally also contain anticorrosion pigments, possibly also in other granularities and/or concentrations.

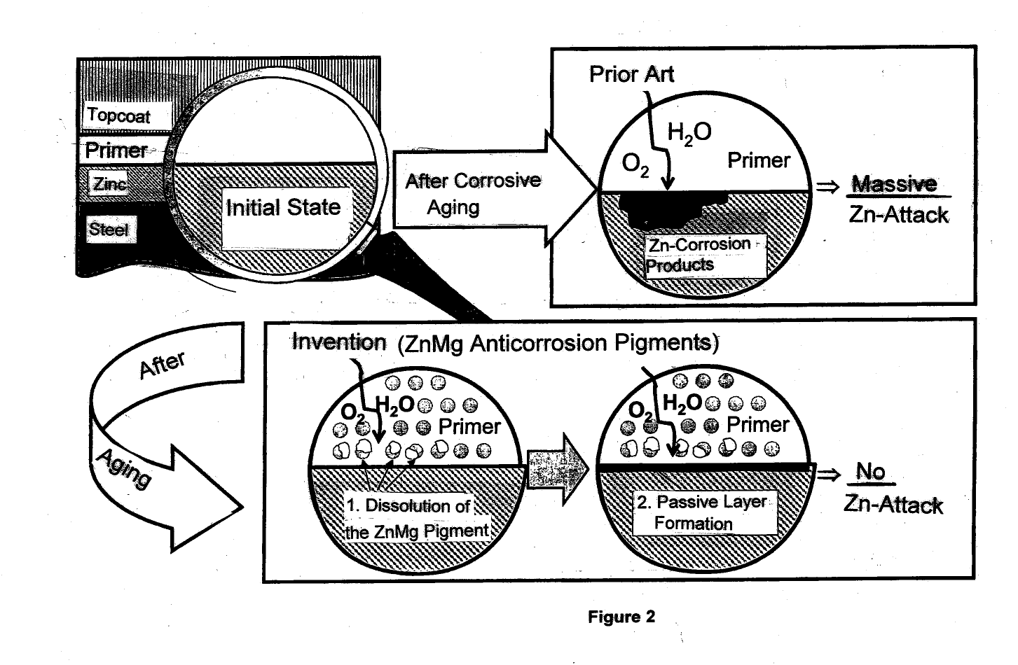

FIG. 2 shows the different reactions to the occurrence of corrosive action in the prior art and according to the invention. In the prior art, upon occurrence of a corrosive action, a direct corrosive action on the zinc layer occurs, thus generating zinc corrosion products.

By contrast, the anticorrosion pigments according to the invention, which according to the invention are contained in the primer 4, are dissolved from a ZnAlMg alloy by means of a corrosive action; a diffusion in the direction toward the surface of the protective layer 2 or 3 clearly occurs and an additional passive layer 5 forms on the surface of this protective layer. This passive layer 5 increases the corrosion resistance and protects the underlying layers from corrosive action.

How this reaction and the formation of the passive layer occur has not yet been conclusively explained.

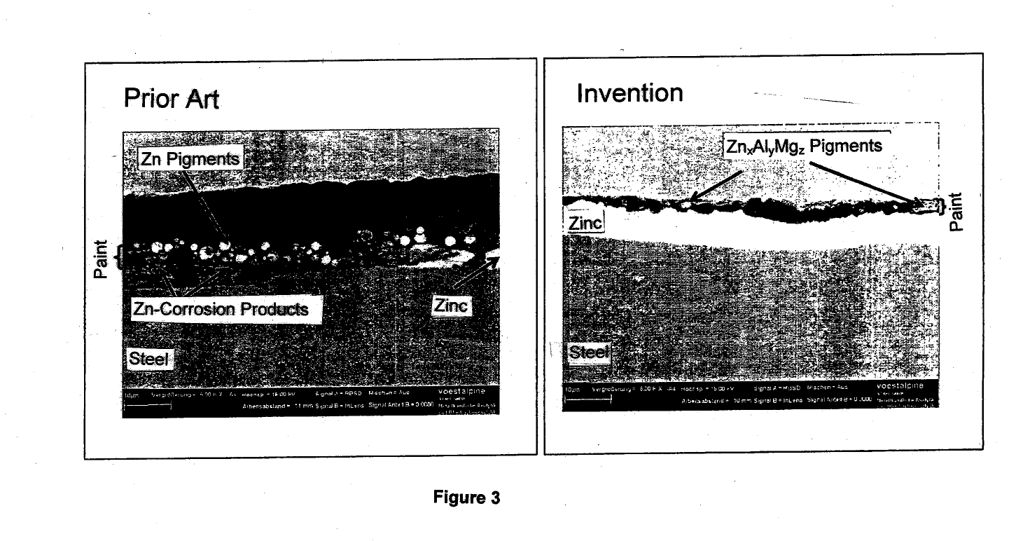

FIG. 3 shows the differences in the structure and function of conventional coatings. The cross-sectional image on the left shows the prior art, in which a conventional anticorrosion primer that contains zinc pigments has been attacked by corrosion in a 500-hour salt-spray test according to DIN EN ISO 9227. It is clear that the zinc pigments are more or less unharmed while zinc corrosion products have built up on the steel substrate and only a small amount of residual zinc is still present.

By contrast, in the cross-sectional image on the right, it is clear that the zinc layer remains largely unchanged after the same corrosive action and the corrosion has in no way penetrated down to the steel. In addition, some residual zinc-magnesium pigments are still present in the primer.

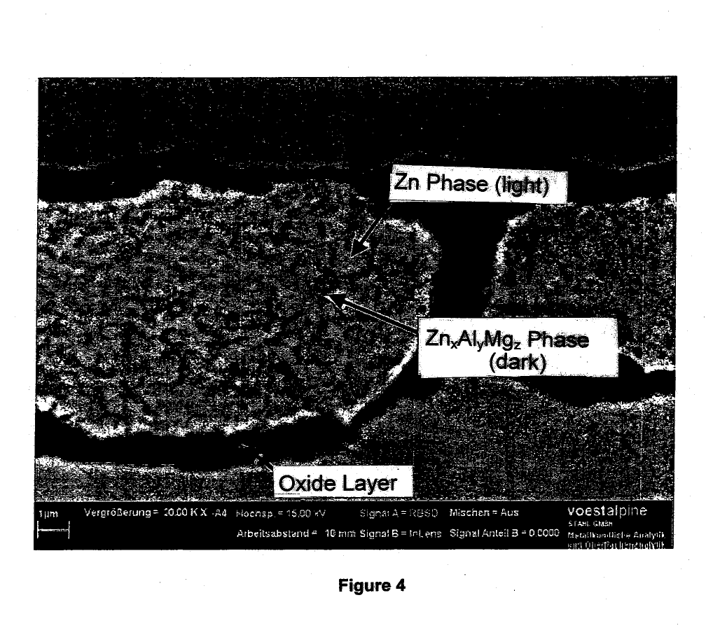

In FIG. 4, a pigment of this kind is shown in close-up; the anticorrosion pigment contains light and dark phases, which are composed of zinc phases and zinc-magnesium alloy phases, and in addition, an oxide layer is present on the outside.

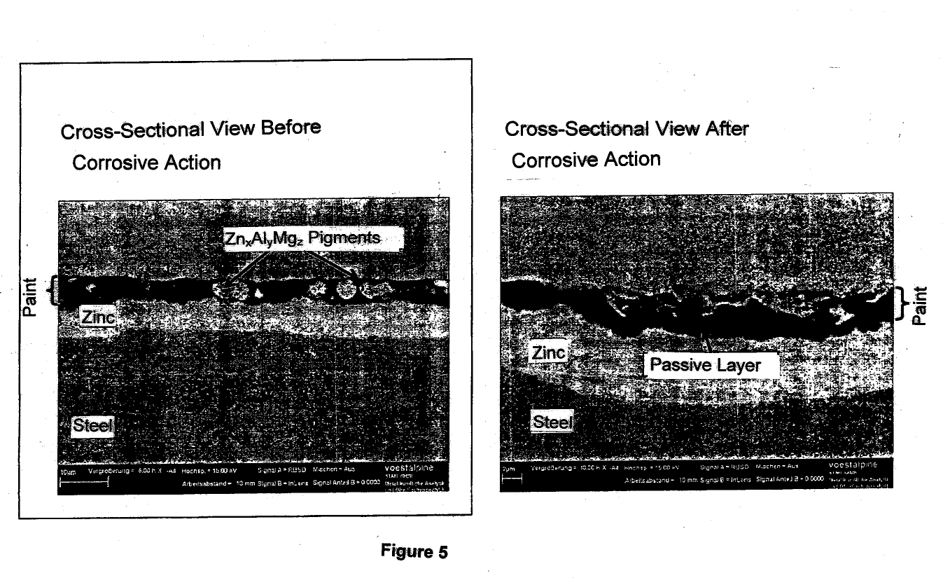

For further illustration, the right side of FIG. 5 once again shows a cross section through the layer structure according to the invention in which, before the corrosive action, the anticorrosion pigments are situated in the organic matrix (black). After the corresponding corrosive action according to DIN EN ISO 9227 (500 hours), it is clearly evident that the anticorrosion pigments have disappeared. However, a thin (light-colored) additional layer has formed on the zinc layer, namely the passive layer that has clearly succeeded in protecting the zinc layer from corrosion.

According to the invention, the above-mentioned pigments can also be contained in adhesives for bonding sheet metals, in particular autobody sheets or sheet metals used for household appliances, thus preventing a corrosion of the joining connection and preventing a detachment of the adhesive due to corrosion of the sheet metal.

In addition, the anticorrosion pigments can naturally also be present in topcoats. If a paint structure of the kind used in autobody sheets is not present, but instead, a simple paint structure is provided of the kind used for example in household appliances and similar applications, then the anticorrosion pigments can also be present in the paint alone.

The invention thus successfully provides an active anticorrosion primer or layer structure that reacts to a corrosive action by precipitating a passive layer, thus making it possible to protect the actual anticorrosion layer. By means of this, this passive layer is then available as a cathodic anticorrosion layer for a cathodic corrosion protection after layer damage (stone impacts, scratches) or in the event of an even more powerful corrosive action.

Consequently, the invention creates a layer structure and anticorrosion pigments that enable a significantly extended service life in the presence of corrosive action.

With the invention, it is also advantageous that by contrast with conventional systems, the weldability is significantly improved and nevertheless, an attractive paint flow is achieved for bodyshell applications. The paint coverage rate is significantly increased, with an outstanding corrosion protection at reduced paint layer thicknesses of 1 to 4 μm, by contrast with the prior 3 to 5 μm. It turned out that it is possible to bridge the gap between corrosion protection on the one hand and weldability on the other, thus enabling a significant improvement in terms of perforation corrosion (flange corrosion) while maintaining the required weldability. In addition, the formability is significantly improved and, through the addition of melamine resins, epoxy resins, or blocked isocyanates, the paint adhesion is also significantly improved.

It is environmentally relevant that by contrast with conventional systems, which required a pretreatment with sometimes carcinogenic contents (chromates, cobalt nitrates), a single-stage, chromate-free pretreatment is possible. In this case, the system can be applied to an extremely wide array of substrates and an extremely wide array of coatings of metals, e.g. Al, Fe, Zn and their alloys.

Another advantage has turned out to be the fact that with the use of the anticorrosion system or structure according to the invention, the baking temperature (peak metal temperature—PMT) of 190° to 240° C. PMT can be reduced to approximately 160° C. PMT so that extremely strong, bake-hardening steels can be painted using coil processing.

A sample composition of a suitable pigment (a pigment with conductive and anticorrosion properties) is given below (all indications in M-%):

Zn/Mg from 90/10 to 99.5/0.5, preferably from 95/5 to 99/1, particularly preferably 98/2.

Zn/Al from 80/20 to 99.5/0.5, preferably from 95/5 to 99/1, particularly preferably 98/2.

If need be, traces of other elements can be present.

The following table illustrates an exemplary embodiment of the invention.

| | |
|---|---|
| Composition | Proportion range in wt. % |

Bonding agents

| | |
|---|---|
| | calculated based on bonding agent/ |
| | preferred |
| polyester resin (branched) | 30.00-50.00%/40% |
| polyester resin (linear) | 15.00-30.00%/20% |
| epoxy resin | 5.00-30.00%/10% |
| melamine resin (hexamethoxymethyl | 10.00-25.00/15% |
| melamine) HMMM | |
| blocked isocyanate (hexamethyl | 10.00-25.00/15% |
| diisocyanate) HDI | |

Additives

| | |
|---|---|
| | calculated based on overall recipe |
| humectant | 0.050-1.000%/0.1% |
| antifoaming agent | 0.100-1.000%/0.25% |
| wetting additive | 0.050-1.000%/0.1% |
| flow-control agent | 0.100-1.000%/0.2% |
| catalyst | 0.500-2.500%/1% |

Pigments

| | |
|---|---|
| conductive pigments | 25.000-40.000%/30% |
| org. Zn-corrosion inhibitors | 0.250-2.000%/1% |
| anticorrosion agent | 4.000-8.000%/6.5% |
| antisettling agent | 0.050-1.000%/0.1% |
| hydrophobizing agent (wax) | 0.250-2.000%/0.5% |

Organic solvents

| | |
|---|---|
| solvent (ester) | 5.000-10.000/7.5% |
| solvent (glycol) | 1.000-10.000/2 1% |
| solvent (aromatic hydrocarbon) | residual trace to 100.000/28.2% |
| <1% naphthalene | |

1. An anticorrosion system for metals composed of at least one covering or coating to be applied to a metal; the covering or coating contains an organic matrix; the organic matrix also contains anticorrosion pigments; the anticorrosion pigments are finely distributed in the organic matrix, and the anticorrosion pigments are made of a metal alloy composed of at least two metals and possibly unavoidable impurities.

2. The anticorrosion system as recited in claim 1, characterized in that the anticorrosion pigments are made of a metal alloy composed of at least three metals and possibly unavoidable impurities.

3. The anticorrosion system as recited in claim 1 or 2, characterized in that the organic matrix is an undercoating for a paint structure and/or an anticorrosion primer for a paint structure and/or a chromophoric paint of a paint structure and/or a topcoat of a paint structure and/or a paint for coating a metal and/or an adhesive for joining metal sheets and/or an oil and/or a wax and/or an oil/wax emulsion.

4. The anticorrosion system as recited in one of the preceding claims, characterized in that the anticorrosion system also includes a metallic covering for the metal substrate; as a protective layer, the metallic covering provides a cathodic corrosion protection or a barrier corrosion protection.

5. The anticorrosion system as recited in one of the preceding claims, characterized in that in a cathodic protective layer, the protective layer is a zinc layer and/or a zinc-aluminum layer and/or a zinc-chromium layer and/or a zinc-magnesium layer and/or a galvannealed layer (zinc-iron layer) or another cathodically acting protective layer.

6. The anticorrosion system as recited in one of the preceding claims, characterized in that a barrier protective layer is composed of aluminum and/or aluminum alloys and/or tin and/or copper and/or other metals that are electrochemically more inert than the covered metal substrate.

7. The anticorrosion system as recited in one of the preceding claims, characterized in that the protective layer is a protective layer that is deposited onto the substrate by means of electrolysis and/or the hot-dip method and/or the PVD method and/or the CVD method.

8. The anticorrosion system as recited in one of the preceding claims, characterized in that at least one of the alloy metals of the anticorrosion pigment corresponds to a metal or the metal of the metallic anticorrosion layer.

9. The anticorrosion system as recited in one of the preceding claims, characterized in that at least two of the metals composing the alloy of the anticorrosion pigment can be alloyed with each other.

10. The anticorrosion system as recited in one of the preceding claims, characterized in that the elements composing the anticorrosion pigment are from different main groups of the chemical periodic system.

11. The anticorrosion system as recited in one of the preceding claims, characterized in that as alloy components, the anticorrosion pigments contain elements of the third, fourth, and fifth periods of the second, third, and fourth main groups and subgroups.

12. The anticorrosion system as recited in one of the preceding claims, characterized in that the anticorrosion pigments are an alloy of metals of the second main group and the second subgroup.

13. The anticorrosion system as recited in one of the preceding claims, characterized in that the alloy for the anticorrosion pigments contains metals of the fourth period of the eighth subgroup.

14. The anticorrosion system as recited in one of the preceding claims, characterized in that zinc, iron, aluminum, magnesium, cerium, lanthanum, and/or chromium are used as metals composing the alloy.

15. The anticorrosion system as recited in one of the preceding claims, characterized in that it contains other metallic pigments.

16. The anticorrosion system as recited in claim 15, characterized in that it contains copper, tin bronze, zinc pigment mixtures, or graphite as other pigments.

17. The anticorrosion system as recited in one of the preceding claims, characterized in that the substrate to which the anticorrosion system is applied is a sheet steel.

18. The anticorrosion system as recited in one of the preceding claims, characterized in that between the metallic protective layer and the protective layer containing the anticorrosion pigments, an intermediate or pretreatment layer is provided, which is composed of a chromating or phosphating, in particular with magnesium, aluminum, or silicon phosphates.

19. The anticorrosion system as recited in one of the preceding claims, characterized in that the alloy of the anticorrosion pigment(s) also contains metals that are electrochemically inert in order to stimulate the breakdown of the alloy components that form the passive layer.

20. The anticorrosion system as recited in claim 19, characterized in that it contains copper, silver, platinum, or gold as the electrochemically more inert metals.

21. The anticorrosion system as recited in one of the preceding claims, characterized in that the organic matrix is essentially a polyester paint.

22. The anticorrosion system as recited in one of the preceding claims, characterized in that for paint adhesion, the organic matrix contains 1 to 5% melamine resins and/or epoxy resins and/or blocked isocyanate resins.

23. The anticorrosion system as recited in one of the preceding claims, characterized in that when used as an anticorrosion primer and/or paint, the anticorrosion system is applied to the substrate in paint layer thicknesses of 1 μm to 4 μm.

24. The anticorrosion system as recited in one of the preceding claims, characterized in that the bonding agent-to-pigment ratio is from 1:1 to 1:4.

25. The anticorrosion system as recited claim 24, characterized in that the bonding agent-to-pigment ratio is from 1:1 to 1:2.

26. The anticorrosion system as recited claim 24, characterized in that the bonding agent-to-pigment ratio is from 1:1.4 to 1:1.6.

27. The anticorrosion system as recited in one of the preceding claims, characterized in that in addition to a paint component and/or resin component, the organic matrix contains waxes as forming additives.

28. The anticorrosion system as recited in one of the preceding claims, characterized in that the matrix contains hydrophobizing agents.

29. The anticorrosion system as recited in one of the preceding claims, characterized in that it contains silanes as hydrophobizing agents.

30. An anticorrosion pigment for use in an anticorrosion system as recited in one of the preceding claims, particularly for use in an organic matrix for protecting a coated or uncoated metal substrate, in which the pigment is made of a metal alloy composed of at least two metals and possibly unavoidable impurities.

31. The anticorrosion pigment as recited in claim 30, characterized in that the anticorrosion pigment is made of a metal alloy composed of at least three metals and possibly unavoidable impurities.

32. The anticorrosion pigment as recited in claim 30 or 31, characterized in that at least one of the alloy metals of the anticorrosion pigment corresponds to a metal or the metal of the metallic corrosion protective layer.

33. The anticorrosion pigment as recited in one of claims 30 through 32, characterized in that at least two of the metals composing the alloy of the anticorrosion pigment can be alloyed with each other.

34. The anticorrosion pigment as recited in one of claims 30 through 33, characterized in that the elements composing the anticorrosion pigment are from different main groups of the chemical periodic system.

35. The anticorrosion pigment as recited in one of claims 30 through 34, characterized in that as alloy components, the anticorrosion pigment contains elements of the third, fourth, and fifth periods of the second, third, and fourth main groups and subgroups.

36. The anticorrosion pigment as recited in one of claims 30 through 35, characterized in that the anticorrosion pigment is an alloy of metals of the second main group and the second subgroup.

37. The anticorrosion pigment as recited in one of claims 30 through 36, characterized in that the alloy for the anticorrosion pigment contains metals of the fourth period of the eighth subgroup.

38. The anticorrosion pigment as recited in one of claims 30 through 37, characterized in that zinc, iron, aluminum, magnesium, cerium, lanthanum, and/or chromium are used as metals composing the alloy.

39. The anticorrosion pigment as recited in one of claims 30 through 38, characterized in that the pigment is essentially a zinc-aluminum-magnesium alloy.

40. The anticorrosion pigment as recited in one of claims 30 through 39, characterized in that the alloy of the anticorrosion pigment(s) also contains metals that are electrochemically more inert than the essential alloy components in order to stimulate the breakdown of the alloy components that form the passive layer.

41. The anticorrosion pigment as recited in one of claims 30 through 40, characterized in that it contains copper, silver, platinum, or gold as metals that are electrochemically more inert than the essential alloy components.

42. A use of the anticorrosion pigment as recited in one of claims 30 through 41 in an anticorrosion system as recited in one of claims 1 through 29 for coating metals as an anticorrosion layer.
